(19) United States
(12) Patent Application Publication
(10) Pub. No.: US 2008/0266744 A1
(43) Pub. Date: Oct. 30, 2008

(54) Electricity conducting wheel structure

(76) Inventor: Li-Lan Yan, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,101

(22) Filed: Apr. 24, 2007

(51) Int. Cl. B60R 16/06

(52) U.S. Cl. 361/217; 361/212; 361/221

(57) ABSTRACT

A multiple electricity conducting wheel is fitted to a vehicle and interposed between two wheel bodies of a wheel of the vehicle, and includes first and second holding members, and a small-diameter electricity conducting roller with an axle supported with the second holding member; the first holding member contains the second holding member, and has two opposing slots, through which the axle of the roller is passed; the second holding member is biased downwards by a spring so as to ensure that the electricity conducting roller will be constantly in contact with the floor; the spring is positioned around a rod part, which is passed through tops of the first and the second holding members, and joined to a metallic hub of the vehicle wheel; thus, static electricity carried on the vehicle can travel to the floor through the electricity conducting wheel.

### BACKGROUND OF THE INVENTION

1. Field of the Invention

The present invention relates to an improvement on a multiple electricity conducting wheel structure, more particularly one, which includes a relatively inexpensive small-diameter electricity conducting roller interposed between two wheel bodies of a wheel of a vehicle for allowing static electricity to travel from the vehicle to the floor.

2. Brief Description of the Prior Art

Patients are usually transported from a sick chamber with vehicles, e.g. wheelchairs and wheeled hospital beds, to the examination division where medical examinations such as computerized axial tomography (CAT) scan and nuclear magnetic resonance radiography are carried out. Therefore, patients can be easily and quickly transferred from a sick chamber to the examination division, resting on such vehicles in either a sitting position or a lying one during the conveyance.

However, when such vehicles are moving, static electricity will be produced thereon owing to the vehicles rubbing against other objects, especially in cold, dry, and low-humidity seasons, which static electricity will cause shock and discomfort to the patients on the vehicles. If a patient is conveyed to a medical examination apparatus with such a vehicle, and has a high-precision medical examination with the medical examination apparatus when resting on the vehicle, static electricity will interfere with the medical examination apparatus. Consequently, errors are prone to happen to the outcome of the examination.

To overcome the above-mentioned problems, the industry developed a kind of device for static electricity interference prevention, which is fitted to casters of wheelchairs/hospital beds. The static electricity interference prevention device includes a holding member joined to a caster of a vehicle, a transverse threaded rod passed though and pivoted on the holding member, a pair of rollers securely joined to two ends of the transverse threaded rod, and an electricity conducting plate. The holding member has an upright pivotal pipe thereon, and a metallic pivotal rod is passed through the upright pivotal pipe, and securely joined at an upper end thereof to a lower end of a leg of the vehicle. The rollers each have an electricity conducting surface layer. The electricity conducting plate is securely joined to a lower end of the metallic pivotal rod to contact inward sides of the electricity conducting surface layers of the rollers at left and right portions thereof. Therefore, static electricity is allowed to travel from the vehicle to the floor through the static electricity interference prevention device.

The rollers with the electricity conducting surface layers are made of a mixture of plastic materials and small metallic pellets, which are relatively time-consuming and difficult to manufacture. Therefore, the manufacturing cost of the rollers is much higher than that of common plastic casters/wheels, and in turn the static electricity interference prevention device isn't competitive.

### SUMMARY OF THE INVENTION

It is an object of the present invention to provide an improvement on an electricity conducting wheel structure, which is fitted to a vehicle for allowing static electricity carried on the vehicle to travel to the floor.

It is another object of the present invention to provide a relatively inexpensive electricity conducting wheel structure of a vehicle to reduce the expense for the users.

An electricity conducting wheel according to an embodiment of the present invention is fitted to a vehicle and interposed between two wheel bodies of a wheel of the vehicle, and includes first and second holding members, and a small-diameter electricity conducting roller with an axle supported with the second holding member. The first holding member receives the second holding member, and has two opposing slots, through which the axle of the roller is passed. The second holding member is biased downwards by a spring so as to ensure that the electricity conducting roller will constantly contact the floor. The spring is positioned around a rod part, which is passed through tops of the first and the second holding members, and joined to a metallic hub of the vehicle wheel. Therefore, static electricity carried on the vehicle is allowed to travel to the floor through the electricity conducting wheel.

### BRIEF DESCRIPTION OF THE DRAWINGS

The present invention will be better understood by referring to the accompanying drawings, wherein:

FIG. 1 is an exploded perspective view of the present invention,

FIG. 2 is a perspective view of the present invention,

FIG. 3 is a vertical sectional view of the present invention, and

FIG. 4 is a view of the present invention being in use.

### DETAILED DESCRIPTION OF THE PREFERRED EMBODIMENTS

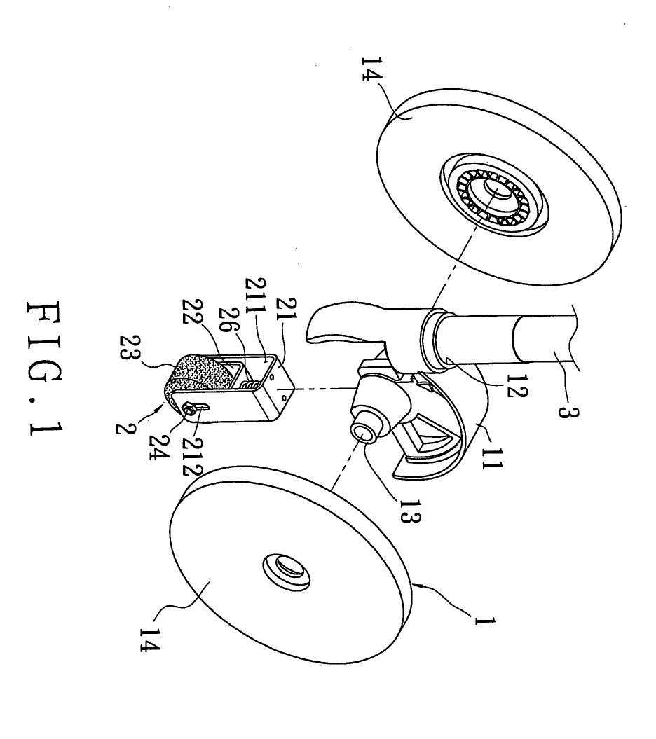

Referring to FIG. 1, a preferred embodiment of an improvement on an electricity conducting wheel structure of the present invention includes a multiple electricity conducting wheel 2, which is joined to a wheel 1 on a lower end of a frame of a vehicle.

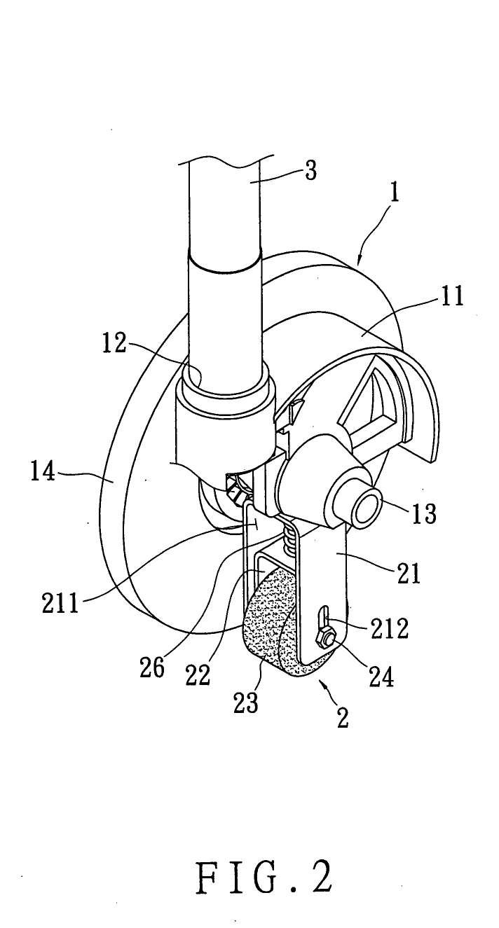

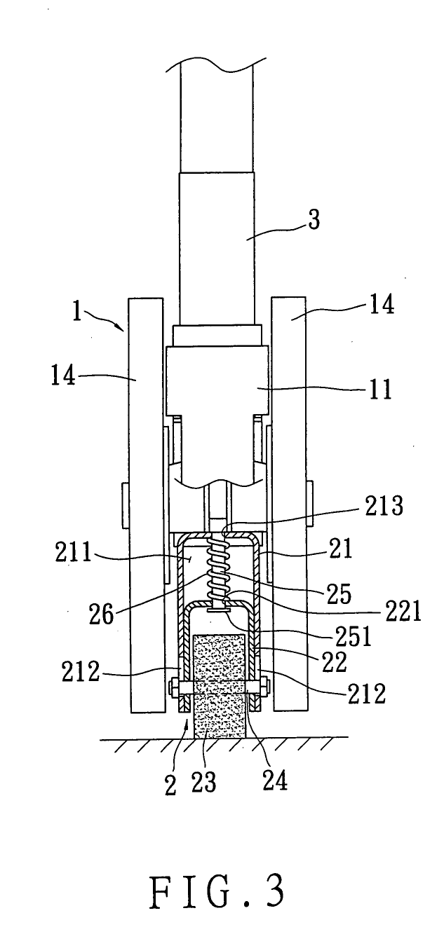

Referring to FIGS. 2 and 3 as well, the vehicle wheel 1 includes:

a metallic hub 11 joined to a lower end of a metallic pivotal rod 3 of the vehicle frame, the metallic hub 11 has a receiving hole 12, in which the metallic pivotal rod 3 is received;

axles 13 projecting from two sides of the metallic hub 11; and

two wheel bodies 14 pivoted on respective ones of the axles 13.

The multiple electricity conducting wheel 2 is positioned between the wheel bodies 14 of the vehicle wheel 1, and securely joined to the metallic hub 11. The multiple electricity conducting wheel 2 includes:

a first inverted U shaped holding member 21, the first inverted U shaped holding member 21 has a holding hollowness 211, and opposing slots 212 on two lateral sides thereof; the first inverted U shaped holding member 21 further has a through hole 213 on a top;

a second inverted U shaped holding member 22 received in the holding hollowness 211 of the first inverted U shaped holding member 21; the second inverted U shaped holding member 22 has a through hole 221 on a top thereof;

an electricity conducting roller 23 received in the second inverted U shaped holding member 22, the electricity conducting roller 23 has a relatively small diameter, and has a pivotal rod 24, which is passed through and pivoted on two lateral sides of the second inverted U shaped holding member 22 at two ends thereof; furthermore, the pivotal rod 24 of the electricity conducting roller 23 is passed through the slots 212 of the first inverted U shaped holding member 21 at the two ends, and joined at the two ends to locating pieces (not numbered) such as nuts, which are used to prevent the pivotal rod 24 from falling off the first inverted U shaped member 21;

a rod part 25, the rod part 25 is passed at a lower end thereof through the through hole 221 of the second inverted U shaped holding member 22 in a loose manner, and is passed at an upper end thereof through the through hole 213 of the first inverted U shaped holding member 21, and joined to the metallic hub 11; the lower end of the rod part 25 has a portion 251 outside the trough hole 221 of the second inverted U shaped holding member 22, which has a size slightly greater than a diameter of the through hole 221; and

an elastic element 26 positioned around the rod part 25 for biasing the second inverted U shaped holding member 22 with the electricity conducting roller 23 away from the top of the first inverted U shaped holding member 21, i.e. downwards, the elastic element 26 can be a spring.

The vehicle is used for transporting a person, with wheels 1 on lower ends of the vehicle frame making the vehicle movable, who is allowed to rest on the vehicle in either a sitting position or a lying one;

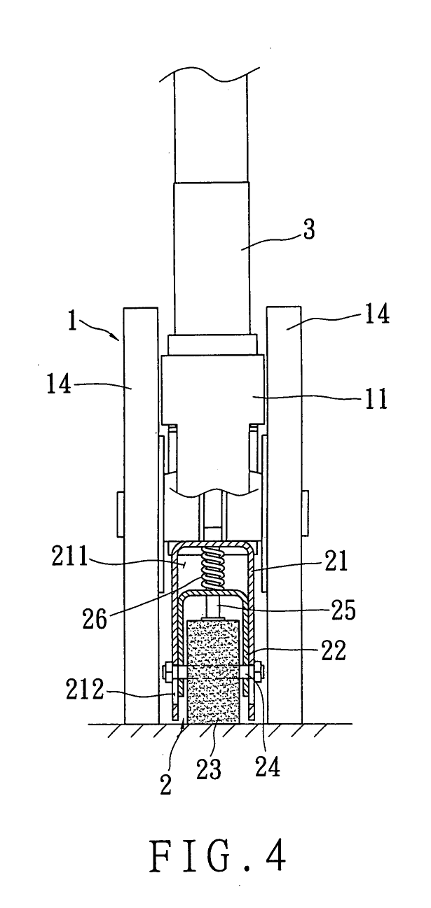

when the vehicle is moving, static electricity will be produced thereon owing to the vehicle rubbing against other objects, especially in cold, dry, and low-humidity seasons, which static electricity will cause shock and 20 discomfort to the person on the vehicle. If the vehicle is used to transport a person to a medical examination apparatus, and the person has a high-precision medical examination with the medical examination apparatuses when resting on the vehicle in a sitting/lying position, the static electricity will interfere with the medical examination apparatus. Consequently, errors are prone to happen to the outcome of the examination. Referring to FIG. 4, when the vehicle is moving on the wheels 1, the electricity conducting roller 23 of the multiple electricity conducting wheel 2 will also be in contact with the floor so as to allow static electricity carried on the vehicle to travel from the vehicle to the floor through it, thus preventing the person resting on the vehicle from being subjected to the static electricity, which will cause shock and discomfort, as well as preventing errors from being caused to the outcome of a medical examination.

Referring to FIG. 4, because of the elastic element 26, when the floor is flat, a bottom of the electricity conducting roller 23 of the multiple electricity conducting wheel 2 will be coplanar with the bottoms of the wheel bodies 14 of the wheel 1 of the vehicle, constantly contacting the floor. Furthermore, when the vehicle is moving on a bumpy floor, the elastic element 25 ensures that the electricity conducting roller 23 will be constantly in contact with the floor so as to help the vehicle move smoothly, and static electricity is allowed to travel from the vehicle to the floor.

From the above description, it can be seen that the present invention has the following advantages over the prior art:

1. The manufacturing cost of the small-diameter electricity conducting roller of the multiple electricity conducting wheel is much less than that of the rollers of the prior art, which has electricity conducting surface layers made of a mixture of plastic materials and small metallic pellets. Therefore, the present invention is more practical and economical to use.

2. The multiple electricity conducting wheel of the present invention allows static electricity carried on the vehicle to travel from the vehicle to the floor through it, thus preventing the person resting on the vehicle from being subjected to the static electricity, which will cause shock and discomfort, as well as preventing errors from being caused to the outcome of a medical examination.

3. The electricity conducting roller is biased down by means of the elastic element, which ensures that the electricity conducting roller will be constantly in contact with the floor so as to allow static electricity carried on the vehicle to travel to the floor always.

What is claimed is:

1. An improvement on an electricity conducting wheel structure, comprising
a multiple electricity conducting wheel, which is joined to a wheel on a lower end of a frame of a vehicle; the vehicle wheel including:
a metallic hub joined to a lower end of a metallic pivotal rod of the vehicle frame, the metallic hub having a receiving hole, in which the metallic pivotal rod is received;
axles projecting from two sides of the metallic hub; and
two wheel bodies each pivoted on a respective said axle;
the multiple electricity conducting wheel being positioned between the wheel bodies of the vehicle wheel, and securely joined to the metallic hub; the multiple electricity conducting wheel including:
(a) a first holding member, the first holding member having a holding hollowness; the first holding member having opposing slots on two lateral sides thereof; the first holding member having a through hole on a top thereof;
(b) a second holding member held in the holding hollowness of the first holding member;
(c) an electricity conducting roller received in the second holding member, the electricity conducting roller having a pivotal rod passed through and pivoted on two lateral sides of the second holding member at two ends thereof; the pivotal rod being passed at the two ends through the slots, and joined to the first holding member in such a manner as to not fall off the first holding member;
(d) a rod part positioned between a top of the second holding member and the first holding member; and
(e) an elastic element positioned around the rod part.

2. The improvement on an electricity conducting wheel structure as recited in claim 1, wherein the second holding member has a through hole on the top thereof, and the first holding member has a through hole on a top thereof; the rod part of the multiple electricity conducting wheel being passed at a first end thereof through the through hole of the top of the second holding member in a loose manner; the rod part being passed at other end thereof through the through hole of the top of the first holding member, and joined to the metallic hub; the first end of the rod part having a portion outside the trough hole of the second holding member, which portion has a size greater than a diameter of the through hole of the second holding member.

3. The improvement on an electricity conducting wheel structure as recited in claim 1, wherein the elastic element is a spring.
